(19) United States
(12) Patent Application Publication
(10) Pub. No.: US 2013/0294478 A1
(43) Pub. Date: Nov. 7, 2013

(54) DEVICE AND METHOD FOR TESTING BLOCK FILTERS

(71) Applicant: ACCESS BUSINESS GROUP INTERNATIONAL LLC, Ada, MI (US)

(72) Inventors: Amy Sue Puroll, Ionia, MI (US); Brian S. Beals, Grand Rapids, MI (US)

(21) Appl. No.: 13/873,330

(22) Filed: Apr. 30, 2013

Related U.S. Application Data
(60) Provisional application No. 61/640,941, filed on May 1, 2012.

(51) Int. Cl. G01N 25/00

(52) U.S. Cl. CPC G01N 25/00
USPC 374/45

(57) ABSTRACT

Testing devices and methods for detecting defects in block filters using temperature differences created by a fluid flow are provided. The testing is relatively fast, inexpensive, and non-destructive, which may allow for testing a relatively large sampling of filters, and possibly all filters produced in a manufacturing process. In one embodiment, the device includes a fluid drive system adapted to create a fluid flow through the filter media. A thermal imaging system is configured to take a thermal image of the filter media. A portion of the filter media without a defect may have a different temperature than a portion of the filter media with a defect. In this manner, a temperature difference detected by the thermal imaging system may indicate that the filter media has a defect. The device may include a fixture for supporting the filter, and may allow for manual or automatic rotation of the filter.

### BACKGROUND OF THE INVENTION

The present invention relates to testing devices and methods for filters, and more particularly to testing devices and methods for detecting defects in block filters.

Filtering is a common process in a many different technology fields, and has led to the creation of a variety of different filter types. For example, many conventional air and water treatment systems incorporate filters to remove particulate matter and other impurities. One of the most common and effective filter types is a carbon block filter. A conventional carbon block filter is a porous, solid filter that includes activated carbon particles held together in a block form by a binder, such as polyethylene. During or after formation of a carbon block filter, the filter can develop defects, such as cracks, holes, voids or other imperfections. For example, the block filter may be formed with defects, or defects may develop during handling of the filter. These defects may provide a flow path that allows fluids to pass more quickly through the filter, without achieving a desired level of filtering.

One known method for testing for defects in water treatment filters involves passing a solution containing methylene blue trihydrate through the filter, and determining the color of the fluid after passing through the filter. The color of the fluid dispensed from the filter may indicate whether the fluid has been properly filtered, and whether the filter includes any defects. However, there are several disadvantages to this method. First, the method is time consuming because of the preparation of the methylene blue solution and the passing of the solution through the filter. Second, the method is relatively expensive because new methylene blue solution must be purchased for each filter and generally may not be reused. Third, the method is destructive in that the filter generally cannot be used and must be discarded after the test. As a result of these disadvantages, only a small sampling of filters are generally tested.

### SUMMARY OF THE INVENTION

The present invention provides testing devices and methods for detecting defects in filters using temperature differences created by a fluid flow. The present invention may allow defects in the filter media, such as cracks or voids, as well as defects in the bond between the filter media and support structure, such as missing glue, to be quickly and easily recognized. The testing is relatively fast, inexpensive, and non-destructive, which may allow for testing a relatively large sampling of filters, and possibly all filters produced in a manufacturing process.

In one embodiment of a test device, the device includes a fluid drive system adapted to create a fluid flow through the filter media. A thermal imaging system is configured to take a thermal image of the filter media, which is configured to display an image representative of a temperature of the filter media. The image may be of the entire filter or only a portion of the filter, such as the filter media. A portion of the filter media without a defect may have a different temperature than a portion of the filter media with a defect. In this manner, a temperature difference detected by the thermal imaging system may indicate that the filter media has a defect. The device may also include a fixture for supporting the filter, and may allow for manual or automatic rotation of the filter.

In other embodiments, the filter and/or the fluid flow may be heated or cooled to create a temperature difference between the fluid flow and the filter.

In one embodiment of a method for testing a filter, the method includes creating a fluid flow through a filter media and detecting temperature differences in the filter media created by the fluid flow to determine whether the filter media has a defect.

In some applications, the filter may include end caps or other support structure that are joined to the filter media. Typically, the support structure and filter media are joined in a way that creates a continuous seal at the interface between the support structure and the filter media. A properly formed seal prevents fluid from flowing through the interface and bypassing the filter media. For example, in some applications, the filter includes end caps that are glued to opposite ends of a carbon block. If the glue at either end is discontinuous or includes voids or other defects, it may be possible for fluid to partially or fully bypass the filter media, which could affect the performance of the filter. In such applications, the present invention may allow voids or other defects in the glue to be quickly and easily recognized. In one embodiment, the various devices and methods described above can be used to recognize voids and other defects in the glue by looking for thermal image differences disposed towards the ends of the filter, for example, in the filter media adjacent to the end caps. In an alternative embodiment, the integrity of the glue bond/seal can be examined by taking a thermal image of the end of the filter after the glue has been applied and while the glue is still warm enough to be thermally distinct from the surrounding structures. Opposite ends of the filter can be tested by taking thermal images of both ends. As an alternative to testing while the glue is still warm from application, the glue can be allow to fully cure and the filter can be reheated to create a thermal difference between the glue and the surrounding structure. With this alternative device and method, a temperature difference between the glue and the surrounding structure will cause the glue to stand out in the thermal image. As a result, an examination of the thermal image will quickly show voids or other defects in the glue. The examination can also show whether too much glue has been applied, which may create aesthetic concern and, if excessive, could affect filter performance.

These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or may be carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a testing device according to one embodiment of the present invention.

FIG. 2 is a thermal image of a filter.

FIG. 3 is a thermal image of a filter.

FIG. 4 is a thermal image of a filter.

FIG. 5 is a perspective view of a testing device according to an embodiment of the present invention.

FIG. 6 is a sectional view of a block filter.

FIG. 7 is a thermal image of one end of the filter.

FIG. 8 is a thermal image another end of the filter.

### DETAILED DESCRIPTION OF THE CURRENT EMBODIMENT

I. Overview

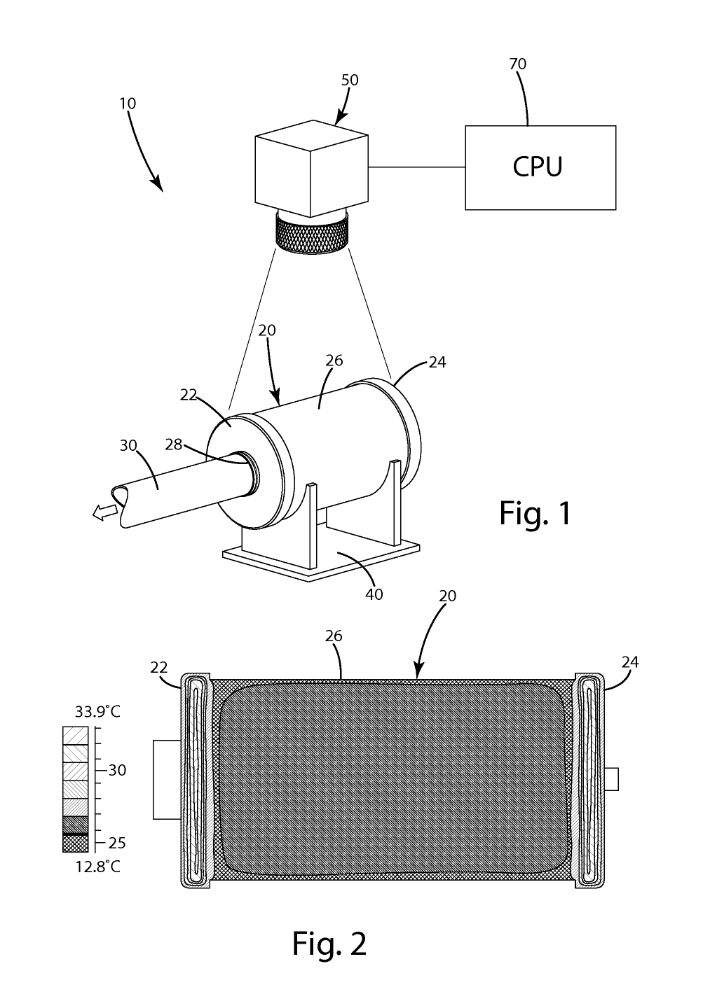

A test device 10 for testing a filter 20 is shown in FIG. 1 and includes a fluid drive system 30 and a thermal imaging system 50. A stand 40 may be included to support the filter 20 during testing. Fluid, such as a liquid or gas, moves through the filter 20 and the thermal imaging system 50 captures a thermal image (e.g. still or video) of the filter 20 to determine whether the filter 20 includes any defects. Although described in the context of carbon block filters, it is contemplated that the test device 10 may be used to test any block filter that is susceptible to defects.

II. Structure

A filter 20 to be tested is shown in FIG. 1. The filter 20 may be any filter that is susceptible to undesirable defects, such as cracks, holes, voids or other imperfections. For example, the filter may be a carbon block filter held together with a polymer binder. In these filters, the carbon/polymer mixture may cure improperly and form a defect in the filter. The filter may also be cracked during or after curing, forming a defect in the filter. The defect may allow fluids to pass more quickly through the filter, without adequate filtering of the fluid. The filter 20 may be any suitable size and shape, including an annular radial flow filter, as shown in FIG. 1. Optionally, the filter 20 may be a linear or non-radial flow filter. As shown in FIG. 1, the filter 20 may be a radial flow filter having two ends 22, 24 (also referred to as “end caps”) that surround a filter media 26. The first end 22 may have an opening 28. A portion of the fluid drive system 30 may be designed to match or be inserted into the opening 28. For example, the opening 28 may receive the portion of the fluid drive system 30 via a friction fit, threaded connection or any other suitable attachment. As shown in FIG. 1, the portion of the fluid drive system 30 received by the first end 22 may be a hose, or other suitable structure. The opening 28 and the portion of the fluid drive system 30 received by the opening 28 may form a sufficiently fluid -tight seal so that the fluid drive system 30 may move fluid through the filter media 26, as described below. The seal may not be completely fluid tight.

A fluid drive system 30 is shown in FIG. 1 and is connected to the filter 20 via the opening 28 in the first end 22. As shown in FIG. 1, the fluid drive system 30 may be adjacent the filter 20 and/or the stand 40. The fluid drive system 30 is connected to the filter 20 to create a fluid flow through the filter media 26. The fluid drive system 30 may be any system capable of moving fluid through the filter media 26, and further may move fluid through the filter media 26 in any direction, including drawing fluid through the filter media 26 and pushing fluid through the filter media 26. For example, the fluid drive system 30 may be a blower motor that drives an airflow radially outward through the filter media 26. Optionally, the fluid drive system 30 may be a vacuum motor that draws air radially inward through the filter media 26. Further optionally, the fluid drive system 30 may be a motor that can toggle between blower and vacuum modes, which would be capable of drawing or pushing air through the filter media 26. Still further optionally, the fluid drive system 30 may also move fluid through the filter media 26 in a linear or other non-radial direction.

A fixture 40 configured to support the filter 20 is included in the test device 10. As shown in FIG. 1, the fixture 40 could be a stand 40 positioned adjacent the filter 20, and the stand 40 may support the filter 20 in a desired orientation to allow an image to be taken of the filter 20 by the thermal imaging system 50. The fixture 40 may be any suitable configuration for supporting the filter 20 and may be designed to properly position the filter 20 for an image to be taken by the thermal imaging system 50. The fixture 40 may be adapted to allow a user to manually rotate the filter 20 while it is on the fixture 40, to obtain thermal images of different sides of the filter 20. Optionally, the fixture 40 may include an automatic rotation system that may automatically rotate or move the filter 20. For example, the automatic rotation system may include a motor or other drive mechanism configured to rotate the filter 20. Further optionally, the fixture 40 may be connected to or part of the fluid drive system 30 to facilitate proper placement of the filter 20 relative to the fluid drive system 30. For example, the fixture 40 may be an inlet or outlet hose in the fluid drive system 30 that supports the filter 20. Still further optionally, the fixture 40 may be connected to or part of the thermal imaging system 50.

A thermal imaging system 50 is shown in FIG. 1 and may be positioned adjacent the filter 20 and/or the stand 40 to determine the temperature of the filter media 26 as the fluid drive system 30 is moving fluid through the filter media 26. Any suitable thermal imaging system 50 may be used, including a thermal video or still camera. The thermal imaging system 50 may take thermal images of the filter media 26 to illustrate temperature differences in the filter media 26. As shown in FIG. 1, the thermal imaging system 50 may be connected to a computer 70 or other suitable user interface for displaying thermal images. Any differences in the temperature of the filter media 26 may be detected and displayed by the thermal imaging system 50 using any suitable method including different colors, shapes or patterns. Optionally, more than one thermal imaging system 50 may be used to capture views from different sides of the filter 20 to reduce or eliminate the need to rotate the filter 20. For example, the system may include four thermal cameras arranged evenly around the filter so that the entire filter 20 can be viewed without rotating the filter 20. Further optionally, the thermal imaging system 50 may be configured to move about the filter 20 to view the entire filter 20. For example, the thermal imaging system 50 may be on a cylindrical track that encircles the filter 20.

In a filter media 26 having no defects, the filter media 26 is uniform, and the uniform movement of air through the filter media 26 may create a uniform temperature in the filter media 26. In a filter media 26 having defects, the filter media 26 is not uniform, and the movement of air through the filter media 26 is not uniform, which causes temperature differences in the filter media 26. For example, the defect may create a low temperature area in the filter media 26 in the area of the defect. In this manner, the fluid flow may be adapted to travel through the filter media 26 and may be adapted to create a temperature difference in the filter media 26.

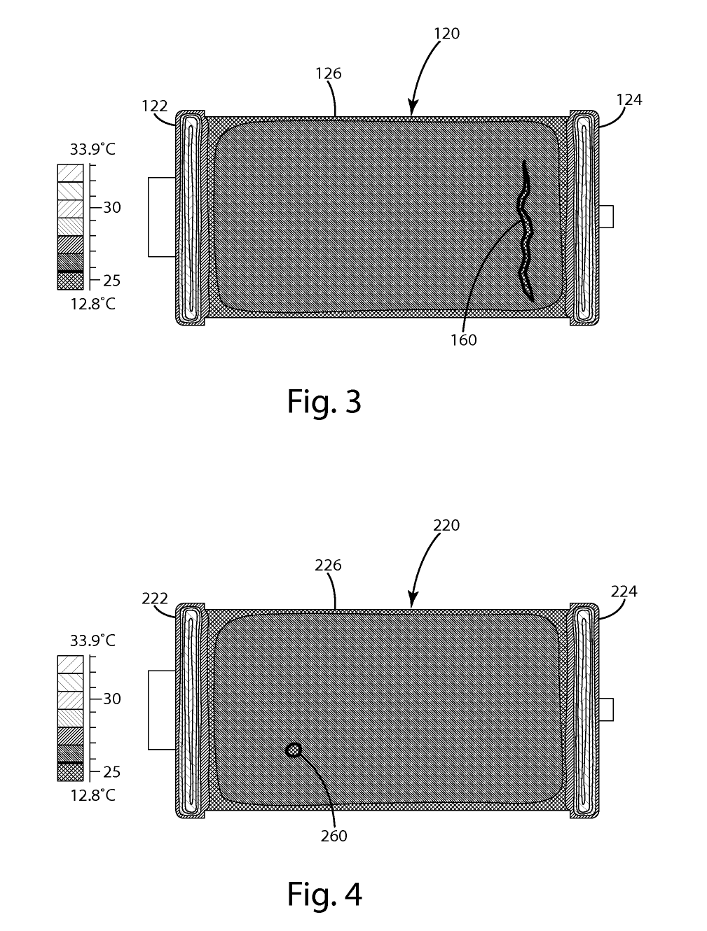

Thermal images of filters are shown in FIGS. 2-4. Although shading is used to indicate temperature in the thermal images in FIGS. 2-4, it should be understood that different colors are more commonly used to indicate temperature in a thermal image. A thermal image of a filter having no defects is shown in FIG. 2. As shown in FIG. 2, the temperature is uniform throughout the filter media 26. In the illustrated embodiment, the ends 22, 24 are made of different material from the filter media 26, which may create a temperature difference between the filter ends 22, 24 and the filter media 26 depending on the temperature conditions surrounding the filter 20. A thermal image of a filter 120 with two ends 122, 124 and a filter media 126 having a defect 160 is shown in FIG. 3. As shown in FIG. 3, the shading indicates that a temperature difference is present in the filter media 126 which may be caused by the defect 160. For example, the defect 160 may cause a low temperature region. As shown in the thermal image, the defect 160 is a crack. By viewing the thermal image, it may be determined that the filter media 126 has a defect 160. A thermal image of another filter 220 with two ends 222, 224 and a filter media 226 having a defect 260 is shown in FIG. 4. As shown in FIG. 4, the shading indicates that a temperature difference is present in the filter media 226 which may be caused by the defect 260. For example, the defect 260 may cause a low temperature region. As shown in the thermal image, the defect 260 is a hole.

By viewing the thermal images created by the thermal imaging system 50 while fluid is moving through the filter, a user may determine whether a filter 20 has any defects. Although defects in the filter media are discussed above, it is also contemplated that defects in the filter ends 22, 24, or defects between the filter ends 22, 24 and the filter media 26 may be detected and identified in the same manner. Further, defects in the bond between the filter ends 22, 24 and the filter media 26 may be identified in the same manner. For example, the process may identify the absence of adhesive in the interface between the filter ends 22, 24 and the filter media 26. Optionally, the thermal imaging system 50 may be connected to a controller programmed to automatically process the thermal images for temperature variation indicating a defect. The controller may use conventional thermal image processing techniques. For example, the controller may be programmed to analyze the images to locate select pixel colors and/or intensity or select changes or differences in pixel colors and/or intensity within the body of the filter media 26. The controller may be programmed to alert a user when a filter has a defect, or may be programmed to automatically direct the filter to a location for filters that fail quality inspection. The testing device 10 allows for quick, inexpensive and non-destructive testing of filters. In some manufacturing processes, virtually all filters produced may be tested as part of the quality control activities associated with the process.

In another embodiment, the fluid flow may be heated and/or the filter media 26 may be cooled to produce a temperature difference between the fluid flow and the filter. For example, the fluid flow may be heated with a heater or other suitable device to a temperature above the ambient temperature before it is moved through the filter media 26. Optionally, the fluid drive system 30 may be adapted to heat the fluid flow as the fluid is moved through the fluid drive system 30. In this configuration, a defect may collect a large concentration of heated fluid, which will appear as an area of elevated temperature in the thermal image taken by the thermal imaging system 50. Optionally, the filter media 26 may be cooled by a cooler, refrigerator or other suitable device to a temperature below the ambient temperature prior to or during movement of fluid through the filter media 26. In this configuration, a defect may collect a large concentration of fluid at a relatively higher temperature than the cooled filter media 26, which will appear as an area of elevated temperature in the thermal image taken by the thermal imaging system 50. Optionally, the fluid flow may be heated and the filter media 26 may be cooled to produce a desired temperature difference.

In another embodiment, the fluid flow may be cooled and/or the filter media 26 may be heated to produce a temperature difference between the fluid flow and the filter media 26. For example, the fluid flow may be cooled by a cooler, refrigerator or other suitable device to a temperature below the ambient temperature before it is moved through the filter media 26. In this configuration, a defect may collect a large concentration of cooled fluid, which will appear as an area of lowered temperature in the thermal image taken by the thermal imaging system 50. Optionally, the filter media 26 may be heated with a heater or other suitable device to a temperature above ambient temperature prior to or during movement of fluid through the filter media 26. In this configuration, a defect may collect a large concentration of fluid at a relatively lower temperature than the heated filter media 26, which will appear as an area of lowered temperature in the thermal image taken by the thermal imaging system 50. Optionally, the fluid flow may be cooled and the filter media 26 may be heated to produce a desired temperature difference.

The present invention may also be used to identify defects in the bond between the filter ends 22, 24 and the filter media 26 through the use of thermal images of the filter ends 22, 24. For example, the filter ends 22, 24 may be secured to the filter media 26 by an adhesive 27 (also referred to as “glue”) and the present invention may be implemented to allow defects in the application of adhesive to be identified. In this embodiment, the filter media 26 is generally cylindrical block (e.g. a carbon block filter) that defines a hollow central through-bore. During manufacture, it is desirable to bond the filter media 26 to the filter ends 22, 24 using adhesive 27 that fully covers the annular ends of the filter media 26. Any voids or gaps in the adhesive 27 may affect the performance or life of the filter 20. Further, an excess of adhesive 27 can also be a defect. In some applications, too much adhesive 27 may merely be aesthetically undesirable. In other applications, too much adhesive 27 can affect performance.

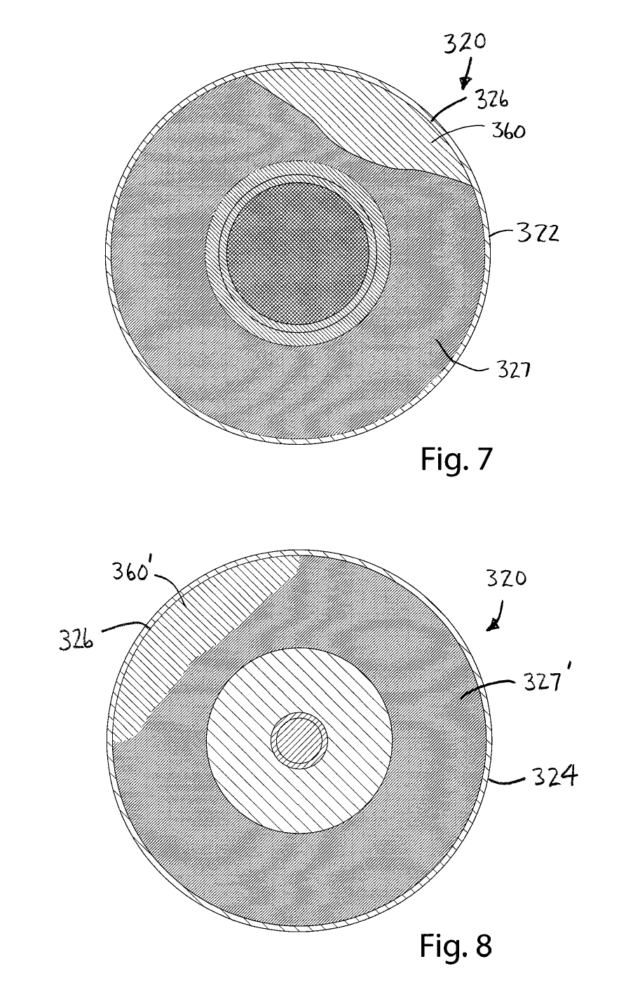

In one embodiment of this aspect of the invention, the test device 10′ may be configured to take thermal images of the filter ends 22, 24 while there is a temperature difference between the adhesive 27 and the surrounding structure, such as the filter ends 22, 24 and the filter media 26. The filter ends 22, 24 may be manufactured from essentially any suitable material, such as plastic, and the adhesive 27 may be essentially any adhesive capable of providing an adequate bond between the filter ends 22, 24 and the filter media 26. In the illustrated embodiment, the filter ends 22, 24 are manufactured from different materials (e.g. different plastics) and the adhesive used to secure the filter ends 22, 24 are different. More specifically, in this embodiment, filter end 22 is manufactured from SABIC LEXAN 244r-WH7D227X and is bonded to the filter media 26 by WSA 2385B DC HM 2510, while filter end 24 is manufactured from Montell ProfaxX 7523 polypropylene and is bonded to the filter media 26 by WSA 2675A Filter Grip AB. Despite variation in the filter end material and the adhesive, temperature differences between the adhesive and the surrounding structure are still apparent in the thermal images (See FIGS. 7 and 8). It should be noted that the filter ends 22, 24 need not be manufactured from different materials, nor involve the use of different types of adhesives. In the illustrated embodiment, the block filter 20 is generally cylindrical and the filter ends 22, 24 are coaxially mounted on opposite end of the filter media 26. In this embodiment, the thermal imaging system 50′ may be positioned to take a thermal image of a filter end 22 or 24 as shown in FIGS. 7 and 8. As shown, the thermal imaging system 50′ may be coaxially aligned with the block filter 20 so that the field of view of the thermal imaging system 50′ includes the major surface of a filter end 22 or 24. When it is desirable to test more than one filter end, the thermal imaging system 50′ may include two cameras positioned on opposite ends of the block filter 20 to take thermal images of both end caps. Alternatively, the thermal imaging system 50′ may include a single camera and the camera or the block filter 20 may be moved to allow thermal images of different filter ends to be captured. The thermal imaging system 50′ and/or the block filter 20 may be moved manually or by automation. For example, the fixture 40 may be mounted on a rotating mount that allows the fixture to be rotated to alternatively place one or the other filter end 22, 24 in the field of view of the thermal imaging system 50′. This may include a fixture 40 capable of rotating 180 degrees. The fixture 40 may be moved manually or may be operate coupled to a motor that automates movement of the fixture. As another example, the thermal imaging system 50′ may be mounted on a carriage (not shown) that can be moved to move the thermal imaging system 50′ from a first position in which the field of view includes one filter end 22 to a second position in which the field of view includes the other filter end 24.

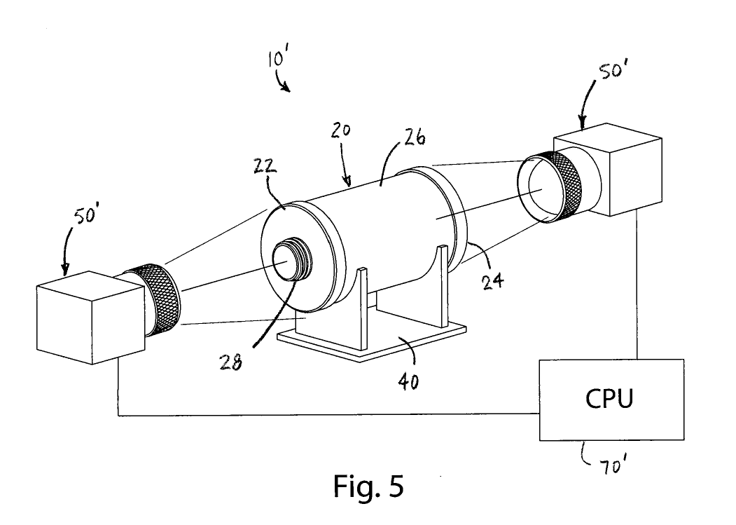

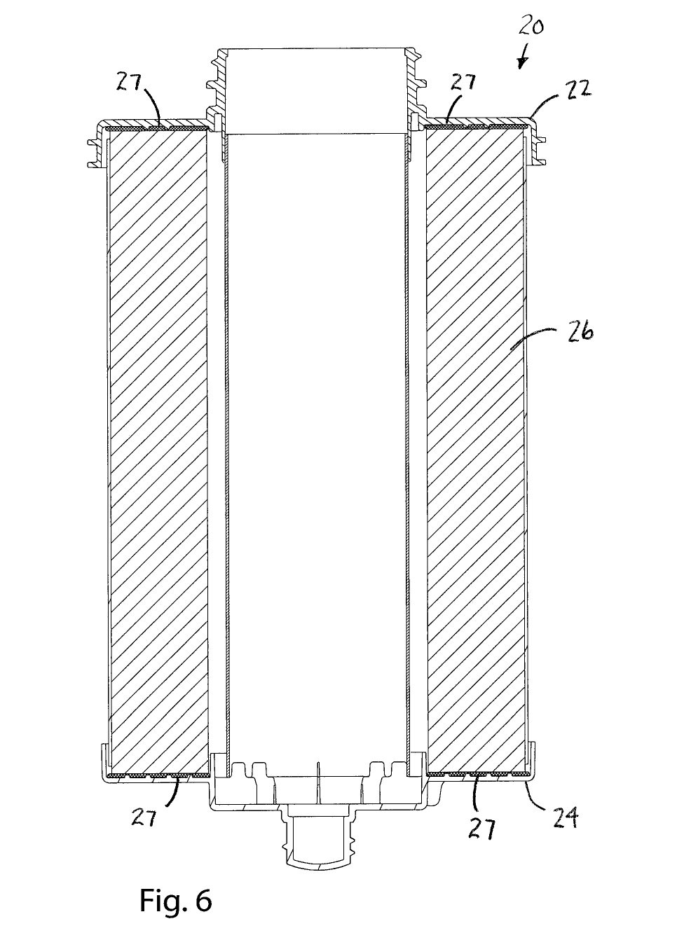

As noted above, the test device 10′ of FIG. 5 is configured to take thermal images of the filters ends 22, 24 while there is a difference between the temperature of the adhesive 27 and the surrounding structure (e.g. filter ends and filter media). This temperature difference may be produced in a variety of different ways depending on the application. In one application, the temperature difference may arise inherently from the filter manufacturing process. More specifically, in this application, the adhesive is heated to a generally liquid state for application between the filter media and the filter ends. In this application, the thermal images may be taken shortly after the filter ends have been secured to the filter media by adhesive and while the adhesive still retains sufficient heat energy to appear different from the surrounding structure in the thermal images. In another application, the temperature difference may be created by heating the filter to induce a temperature difference. For example, in this application, the test device 10′ may include a heater, such as an oven, a heat lamp or other heat source, that is capable of heating the filter. In this application, the adhesive will heat more slowly than the surrounding structure, thereby creating a temperature difference that can be identified in a thermal image.

III. Method of Use

A method for testing a filter is provided that includes creating a fluid flow through the filter media 26 and detecting temperature differences in the filter media 26 created by the fluid flow to determine whether the filter media 26 defines a defect.

In use, the stand 40 may be placed in a proper location for viewing by the thermal imaging system 50. A filter 20 may be placed in the stand 40, and the fluid drive system 30 may be provided and connected to the filter 20 via opening 28. The fluid flow may be created through the filter media 26 by activating the fluid drive system 30. After a time, the fluid flow may create a temperature difference in the filter media 26. After the fluid drive system 30 is allowed a sufficient time to move fluid through the filter media 26, the thermal imaging system 50 may capture a thermal image of the filter media 26 to detect any temperature differences in the filter media 26. The user may rotate the filter 20 in the stand 40 to capture images of all sides of the filter 20, or the stand 40 may include an automatic rotation system for rotating the filter 20. Optionally, multiple thermal imaging systems 50 may be used to capture images of all sides of the filter 20 while the filter 20 is stationary in the stand 40. Further optionally, the thermal imaging system 50 may be configured to move about the filter 20 as described above to capture images of different sides of the filter 20 while the filter 20 remains stationary.

By detecting and displaying temperature differences in the filter media 26, the thermal image may indicate whether the filter media 26 has any defects. The thermal images may be inspected with any suitable method to determine whether the filter media 26 has any defects, including visual inspection by a user and automatic electronic inspection by a controller. As noted above, the image may be analyzed by a controller having image processing software. The controller may analyze the images by looking for select pixel colors and/or intensity or select changes or differences in pixel colors and/or intensity within the body of the filter media 26.

In another embodiment, the method may include heating the fluid flow and/or cooling the filter media 26, or cooling the fluid flow and/or heating the filter media 26 as described above. In this manner, a desired temperature difference may be created between the fluid flow and the filter media 26 to emphasize the presence of a defect. As described above, the fluid drive system 30 may be configured to heat the fluid flow as it is moved through the fluid drive system 30.

As noted above, the present invention may also be used to identify defects in the bond between the filter ends 22, 24 and the filter media 26 through the use of thermal images of the filter ends 22, 24. In this aspect, the method generally includes the steps of bonding a filter end 22 or 24 to a filter media 26 with an adhesive 27, taking a thermal image of the filter end 22 or 24 using a thermal imaging system 50 having a field of view including the filter end 22 or 24 while there is a difference in the temperature of the adhesive 27 and the filter media 26 and identifying defects in the adhesive 27 based on temperature differences presented in the thermal image.

The method may be implemented to test either or both filter ends 22, 24. For example, separate thermal images of opposite filter ends 22 and 24 may be taken and analyzed to test for defects in the bonding of both. Separate thermal images may be taken by separate cameras positioned on opposite ends of the filter 20. A single camera may be used by either rotating the filter 20 to allow a fixed camera to take thermal images of opposite filter ends 22, 24 or by moving the camera around a fixed filter 20. In either case, motion of the filter or the camera may be achieved manually or through automation. For example, the fixture 40 may be capable of rotating 180 degrees either manually or via an automated rotation system (such as a motor and appropriate linkage (not shown)). As another example, the camera may be mounted on an automated movement assembly (not shown) that allows the camera to be moved to opposite ends of the filter 20. The automated movement assembly may be essentially any mechanism capable of selectively moving the camera, such as a carriage mounted on rails or a robotic arm capable of moving the camera.

The step of bonding the filter end(s) 22 or 24 may include heating the adhesive 27 to a generally liquid state, applying the generally liquid adhesive 27 between the filter end 22 or 24 and the filter media 26 and pressing the filter end(s) 22, 24 onto the filter media 26. In embodiments in which the adhesive 27 is heated for application, the present invention may rely on the temperature difference between the heated adhesive 27 and the surrounding structure. For example, the thermal image may be taken while the heated adhesive 27 remains warmer than the surrounding structure so that the presence or absence of adhesive 27 can be readily identified in a thermal image. The thermal imaging system 50 may be positioned near the manufacturing equipment so that the thermal images may be taken shortly after bonding of the filters ends 22, 24 to the filter media 26.

In some applications, the method may include the step of heating the filter 20 to create a temperature difference between the adhesive 27 and the surrounding structure. In these embodiments, the temperature difference may result from the adhesive 27 heating at a different rate (e.g. more slowly) than the filter media 26 and the filter ends 22, 24. This approach may be particularly useful when it is desirable to test a filter after the adhesive has cooled from the bonding step, or in situations where the adhesive is not heated during bonding.

The step of identifying defects will now be described with reference to FIGS. 7 and 8. FIG. 7 is a thermal image of the filter 320 taken from an end showing filter end 322. This image shows the filter 320 after it has been heated to create a temperature difference between the adhesive 327 and the surrounding structure (e.g. filter end 322 and filter media 326). In this embodiment, it is intended during manufacture to apply adhesive between the filter end 322 and the filter media 326 over substantially the entire annular end of the filter media 326. By examining the image in the annular region corresponding to the end of filter media 326 where adhesive should be applied, it can be seen that there is a substantial temperature difference between region 360 and region 327. In this case, region 327 is cooler than region 360. The temperature difference arises because region 327 includes adhesive 27 while region 360 does not (adhesive 27 does not heat as quickly as the filter media 326 and filter end 322). In this embodiment, the absence of adhesive in a portion of the annular end of the filter media 326 is a manufacturing defect. When adhesive is properly applied, region 327 will extend over substantially the entire annular end of the filter media 326 and there will be no warmer regions, such as region 360.

FIG. 8 is a thermal image of the filter 320 similar to FIG. 7, except that it is taken from the opposite end showing filter end 324. Again, this image shows the filter 320 after it has been heated to create a temperature difference between the adhesive 327 and the surrounding structure (e.g. filter end 324 and filter media 326). By examining the annular region corresponding with the end of the filter media, it can be seen that there is a substantial temperature difference between region 360′ and region 327′. In this case, region 327′ (which contains adhesive 27) is cooler than region 360′ (which contains no adhesive 27). As can be seen, region 360′ represents a defect in the application of adhesive.

FIGS. 7 and 8 demonstrate the identification of defects when the filter 20 is heated to produce a temperature difference between the adhesive 27, the filter ends 22, 24 and the filter media 26. In alternative embodiments where the thermal images are taken while the adhesive is still warm from manufacture, the adhesive will have a higher temperature than the surrounding structure. Accordingly, regions that include adhesive will appear at a higher temperature than regions without adhesive. This will need to be taken into account when analyzing the thermal images to identify any defects.

As noted above, the thermal images may be analyzed manually, for example, by a human being examining the images to locate temperature differences representative of a defect, or using a computer/controller capable of automating the process of identifying temperature differences representative of a defect.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Features of various embodiments may be used in combination with features from other embodiments. Directional terms, such as “vertical,” “horizontal,” “top,” “bottom,” “front,” “rear,” “upper,” “lower,” “inner,” “inwardly,” “outer,” “outwardly,” “forward,” and “rearward” are used to assist in describing the invention based on the orientation of the embodiments shown in the illustrations. The use of directional terms should not be interpreted to limit the invention to any specific orientation(s). Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A device for testing a block filter having a filter media comprising:
a fixture configured to support the block filter;
a fluid drive system adjacent the fixture, the fluid drive system adapted to create a fluid flow through the filter media; and
a thermal imaging system adjacent the fixture, the thermal imaging system configured to take at least one thermal image of the filter media, the at least one thermal image of the filter media configured to display an image representative of a temperature of the filter media.

2. The device of claim 1 wherein the fixture is connected to the fluid drive system.

3. The device of claim 1 wherein the fluid drive system is at least one of a vacuum and a blower, and wherein the fluid flow is an airflow.

4. The device of claim 3 wherein the fixture is adapted to allow manual rotation of the block filter.

5. The device of claim 3 including an automatic rotation system having a motor configured to rotate the block filter.

6. The device of claim 1 including a heater adapted to heat the filter media to a temperature above an ambient temperature.

7. The device of claim 1 including a cooler adapted to cool the filter media to a temperature below an ambient temperature.

8. The device of claim 1 wherein the fluid flow has a temperature at least one of above and below an ambient temperature.

9. The device of claim 8 wherein the fluid drive system is adapted to heat the fluid flow.

10. The device of claim 1 including a controller adapted to automatically process the at least one thermal image and determine whether the filter media has a defect.

11. A device for detecting a defect in a block filter having a filter media comprising:
a fixture adapted to support the block filter;
a fluid flow adapted to travel through the filter media, the fluid flow adapted to create a temperature difference in the filter media; and
a thermal imaging system adjacent the fixture, the thermal imaging system adapted to determine a temperature of the filter media.

12. The device of claim 11 including a fluid drive system for creating the fluid flow, wherein the fixture is at least one of connected to and a part of the fluid drive system.

13. A method for testing a block filter having a filter media comprising:
connecting a fluid drive system to the block filter, the fluid drive system adapted to create a fluid flow;
creating a fluid flow through the filter media with the fluid drive system; and
detecting a temperature of the filter media with a thermal imaging system to determine whether the filter media has a defect.

14. The method of claim 13 including placing the block filter in a fixture.

15. The method of claim 13 wherein the detecting a temperature step includes detecting a low temperature area of the filter media relative to a remainder of the filter media and identifying the low temperature area of the filter media as a defect in the filter media.

16. The method of claim 13 wherein the creating a fluid flow step includes creating an airflow radially outward through the filter media using a blower.

17. The method of claim 16 including heating the airflow with the blower.

18. The method of claim 13 wherein the creating a fluid flow step includes creating an airflow radially inward through the filter media using a vacuum.

19. The method of claim 13 including heating the filter media to create a temperature difference between the fluid flow and the filter media.

20. The method of claim 13 including cooling the filter media to create a temperature difference between the fluid flow and the filter media.

21. A device for detecting a defect in a block filter having an end cap secured to a filter media comprising:
a fixture adapted to support the block filter;
a thermal imaging system adjacent the fixture and adapted to obtain a thermal image of the block filter, the thermal imaging system having a field of view encompassing the end cap; and
a controller adapted to automatically process the thermal image and determine whether there is a defect in a bond between the end cap and the filter media, said controller recognizing a defect in said bond based on temperature difference present in said thermal image.

22. The device of claim 21 including a heater adapted to heat the block filter.

23. The device of claim 21 wherein the block filter include two end caps disposed on opposite ends of the filter media, the thermal imaging system adapted to obtain a thermal image of a first of the end caps of the block filter; and
further including a second thermal imaging system adjacent the fixture to obtain a thermal image of the block filter, the second thermal imaging system having a field of view encompassing a second of the end caps of the block filter.

24. The device of claim 21 wherein the block filter include two end caps disposed on the filter media, said fixture adapted to allow manual rotation of the block filter to allow the thermal imaging system to obtain separate thermal images of each end cap.

25. The device of claim 21 wherein the block filter include two end caps disposed on the filter media, and further including an automatic rotation system having a motor configured to rotate the block filter to allow the thermal imaging system to obtain separate thermal images of each end cap.

26. The device of claim 21 wherein the block filter include two end caps disposed on the filter media, and further including an automatic thermal imaging system having an automated movement assembly configured to move the thermal imaging system to allow the thermal imaging system to obtain separate thermal images of each end cap.

27. A method for testing a block filter comprising:
bonding an end cap to a filter media using an adhesive;
taking a thermal image of the block filter using a thermal imaging system having a field of view including the end cap while there is a difference in the temperature of the adhesive and the filter media, whereby the presence and absence of adhesive is manifested in differences in the thermal image; and
detecting a defect in the bond between the end cap and the filter media by analyzing differences in the thermal image.

28. The method of claim 27 wherein said bonding step includes heating the adhesive to a melting point and applying the heated adhesive between the end cap and the filter media.

29. The method of claim 27 wherein said taking a thermal image of the block filter includes taking a thermal image while the adhesive remains substantially above ambient temperature.

30. The method of claim 29 wherein said step includes detecting a low temperature area of the end cap relative to a remainder of the end cap and identifying the low temperature area as an absence of adhesive.

31. The method of claim 30 including heating the block filter to create a temperature difference between the adhesive and the end cap.

32. The method of claim 31 including the step of automatically processing the thermal image with a controller to determine whether there is a defect in a bond between the end cap and the filter media, the controller recognizing a defect in said bond based on temperature difference present in said thermal image.

33. The method of claim 27 further including the steps of:
bonding a second end cap to the filter media using an adhesive;
taking a second thermal image of the block filter using a thermal imaging system having a field of view including the second end cap; and
detecting a defect in the bond between the second end cap and the filter media by analyzing differences in the second thermal image.

34. The method of claim 21 further including the step of heating the filter block prior to said step of taking a thermal image.
